(19) United States
(12) Patent Application Publication
(10) Pub. No.: US 2025/0048293 A1
(43) Pub. Date: Feb. 6, 2025

(54) A TIME MANAGEMENT SYSTEM

(71) Applicant: TURKCELL TEKNOLOJI ARASTIRMA VE GELISTIRME ANONIM SIRKETI, Istanbul (TR)

(72) Inventor: Mehmet Izzet SAGLAM, Istanbul (TR)

(73) Assignee: TURKCELL TEKNOLOJI ARASTIRMA VE GELISTIRME ANONIM SIRKETI, Istanbul (TR)

(21) Appl. No.: 18/715,279

(22) PCT Filed: Dec. 28, 2022
(86) PCT No.: PCT/TR2022/051644

§ 371 Date: May 31, 2024

(30) Foreign Application Priority Data
Dec. 28, 2021 (TR) 2021/021346

(51) Int. Cl. H04W 56/00

(52) U.S. Cl. CPC H04W 56/0045; H04W 56/006

(57) ABSTRACT

The present invention relates to a system which enables to regulate the timing advance value for preventing uplink requests of signals of different user equipments from causing interference in 5G next generation non-terrestrial connections.

### TECHNICAL FIELD

The present invention relates to a system which enables to regulate the timing advance value for preventing uplink requests of signals of different user equipments from causing interference in 5G next generation non-terrestrial connections.

### BACKGROUND OF THE INVENTION

Installation of 5G commercial terrestrial networks was started in 2019 and its feasibility was completed upon the preparation of TR 38.821 report in non-terrestrial networks (Non-Terrestrial Networks, NTN) 3GPP Rel-16 as of June 2020. The subject of non-terrestrial networks was studied within the scope of 3GPP Rel-17 between the dates of June 2020 and June 2022 and the integration of present 5G terrestrial networks with non-terrestrial networks will be completed as a result of this study.

At present, time control and synchronization is provided in 5G NR terrestrial networks by means of SS (Synchronization Signal) and PBCH (Physical Broadcasting Channel) channels. The user equipment (UE) can provide synchronization although there are long distances for downlink (DL), when it is used in non-terrestrial 5G NR networks similarly. However, the same terms do not apply for uplink (UL). Therefore, data and signalling in the upstream (UL) cause problems for long distances where non-terrestrial networks operate. One of the said problems is that the UL signal or data received from different user equipment (UE) may cause interference for each other in the same base station (gNodeB).

Therefore, today there is need for solutions which will prevent uplink requests of signals of user equipments.

The United States patent document no. US20180167883, an application in the state of the art, discloses a system for beam management in next generation wireless communication networks. In the system included in the said invention, beam management is performed by means of a configuration information sent from a user equipment and the timing of beam management is regulated. In the said invention, the user equipment can be tracked by means of the remote area network location information in the next generation wireless communication networks and the location changes of the user equipment can be tracked by performing the location update automatically. In the current invention, a user equipment, which can carry out the transaction of capturing a beam synchronised with a uplink, transmits a regulating signal; transmits a control signal by means of a downlink from a network node; a beam is selected by transmitting the control signal via the user equipment.

### SUMMARY OF THE INVENTION

The objective of the present invention is to realize a system which enables to regulate the timing advance value for preventing uplink requests of signals of different user equipments from causing interference in 5G next generation non-terrestrial connections.

### DETAILED DESCRIPTION OF THE INVENTION

The “Time Management System” realized to fulfil the objective of the present invention is shown in the figures attached, in which:

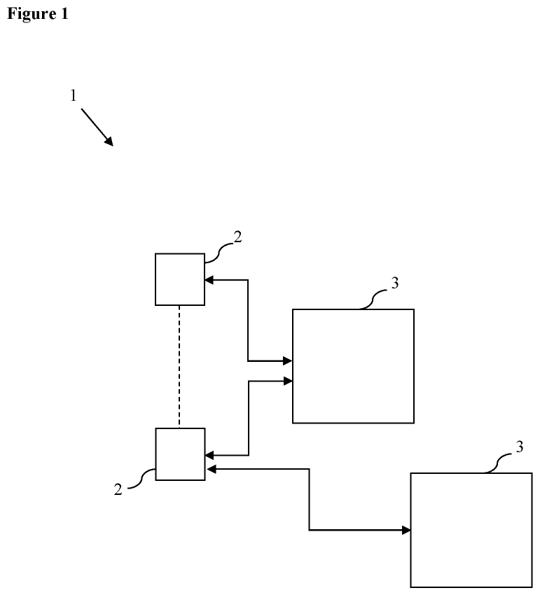

FIG. 1 is a schematic view of the inventive system.

The components illustrated in the FIGURE are individually numbered, where the numbers refer to the following:
1. System
2. User equipment
3. Base station

The inventive system (1) which enables to regulate the timing advance value for preventing uplink requests of signals of different user equipments from causing interference in 5G next generation non-terrestrial connections comprises:
a plurality of user equipments (2) which are configured to get service from 5G next generation radio network, to create the timing advance information automatically, and to receive the location information from mobile networks or global navigation satellite system (GNSS); and
at least one base station (3) which is configured to serve in 5G next generation radio network, to provide network service in non-terrestrial locations, to receive the timing advance information by connecting to the user equipments (2) by means of uplink (UL) request, to receive the location information from the user equipment (2) that cannot send timing advance information and to calculate the timing advance information according to location information; to calculate the precise timing advance value by adding the shared timing advance for each user equipment (2) to the timing advance of the user equipment (2).

The electronic equipment (2) included in the inventive system (1) is configured to receive the uplink request particularly received from the base stations (3), to create the timing advance automatically, and to share the timing advance information with the base station (3). The electronic equipment (2) is configured to receive the location information from global navigation satellite system (GNSS) in the event that it cannot share the timing advance information, and to share the location information with the base station (3).

The base station (3) included in the inventive system (1) is configured to serve in non-terrestrial networks, to control the timing advance information based on the user equipment (2) with the shared timing advance data, to send request to the user equipment (2) for creating the timing advance based on the user equipment if there is no timing advance based on the user equipment (2). The base station (3) is configured to calculate the total timing advance by the shared timing advance value and the user-based timing advance for the uplink connection in the event that there is timing advance based on the user equipment (2). The base station (3) is configured to calculate the total timing advance if it can direct the timing advance based on the user equipment (2) to the network and to request the location information from the user equipment (2) if it cannot direct. The base station (3) is configured to obtain the location information from the global navigation satellite system in the event that the user equipment (2) has a global navigation satellite system (GNSS) and to share it with the base station. The base station (3) is configured to calculate the location information from ephemeris or its distance to other terrestrial and non-terrestrial base stations in the event that the user equipment (2) has no global navigation satellite system (GNSS). The base station (3) is configured to use the last calculated timing advance of the user equipment (2) or the location information of the user equipment (2) for the purpose of avoiding interference.

The inventive system (1) discloses a time control transaction for 5G and beyond non-terrestrial networks and the invention can be implemented without being changed for time control in 3GPP standards. Thereby, significant protocol changes are avoided on both network and user equipment (2) part.

Within these basic concepts; it is possible to develop a wide variety of embodiments of the inventive “Time Management System (1)”; the invention cannot be limited to examples disclosed herein and it is essentially according to claims.

1. A system (1) which enables to regulate the timing advance value for preventing uplink requests of signals of different user equipments from causing interference in 5G next generation non-terrestrial connections; characterized by
a plurality of user equipments (2) which are configured to get service from 5G next generation radio network, to create the timing advance information automatically, and to receive the location information from mobile networks or global navigation satellite system (GNSS); and
at least one base station (3) which is configured to serve in 5G next generation radio network, to provide network service in non-terrestrial locations, to receive the timing advance information by connecting to the user equipments (2) by means of uplink (UL) request, to receive the location information from the user equipment (2) that cannot send the timing advance information and to calculate the timing advance information according to the location information; to calculate the precise timing advance value by adding the shared timing advance for each user equipment (2) to the timing advance of the user equipment (2).

2. A system (1) according to claim 1; characterized by the electronic equipment (2) which is configured to receive the uplink request particularly received from the base stations (3), to create the timing advance automatically, and to share the timing advance information with the base station (3).

3. A system (1) according to claim 1; characterized by the electronic equipment (2) which is configured to receive the location information from global navigation satellite system (GNSS) in the event that it cannot share the timing advance information, and to share the location information with the base station (3).

4. A system (1) according to claim 1; characterized by the base station (3) which is configured to serve in non-terrestrial networks, to control the timing advance information based on the user equipment (2) with the shared timing advance data, to send request to the user equipment (2) for creating the timing advance based on the user equipment if there is no timing advance based on the user equipment (2).

5. A system (1) according to claim 1; characterized by the base station (3) which is configured to calculate the total timing advance by the shared timing advance value and the user-based timing advance for the uplink connection in the event that there is timing advance based on the user equipment (2).

6. A system (1) according to claim 1; characterized by the base station (3) which is configured to calculate the total timing advance if it can direct the timing advance based on the user equipment (2) to the network and to request the location information from the user equipment (2) if it cannot direct.

7. A system (1) according to claim 1; characterized by the base station (3) which is configured to obtain the location information from the global navigation satellite system in the event that the user equipment (2) has a global navigation satellite system (GNSS) and to share it with the base station.

8. A system (1) according to claim 1; characterized by the base station (3) which is configured to calculate the location information from ephemeris or its distance to other terrestrial and non-terrestrial base stations in the event that the user equipment (2) has no global navigation satellite system (GNSS).

9. A system (1) according to claim 1; characterized by the base station (3) which is configured to use the last calculated timing advance of the user equipment (2) or the location information of the user equipment (2) for the purpose of avoiding interference.
